(19) United States
(12) Patent Application Publication
(10) Pub. No.: US 2025/0382200 A1
(43) Pub. Date: Dec. 18, 2025

(54) ULTRAVIOLET (UV) DIGESTION APPARATUS

(71) Applicant: Taiwan Semiconductor Manufacturing Company Limited, Hsin-Chu (TW)

(72) Inventors: En Tian Lin, Taoyuan City (TW); Chiao-Ling Weng, Taichung City (TW)

(21) Appl. No.: 18/744,809

(22) Filed: Jun. 17, 2024

(51) Int. Cl. C02F 1/32; C02F 1/00; C02F 101/20; C02F 103/34; G01N 15/075

(52) U.S. Cl. CPC C02F 1/325; C02F 1/004; G01N 15/075; C02F 2101/20; C02F 2103/346; C02F 2201/3223; C02F 2201/3228

(57) ABSTRACT

An ultraviolet (UV) digestion apparatus is provided. The UV digestion apparatus includes a liquid holder defining a chamber. The UV digestion apparatus includes a light source configured to emit UV light to the chamber.

### BACKGROUND

Semiconductor devices are formed on, in, and/or from semiconductor wafers, and are used in a multitude of electronic devices, such as mobile phones, laptops, desktops, tablets, watches, gaming systems, and various other industrial, commercial, and consumer electronics. One or more semiconductor fabrication processes are performed to form semiconductor devices on, in, and/or from a semiconductor wafer.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A illustrates a perspective view of an ultraviolet (UV) digestion apparatus, in accordance with some embodiments.

FIG. 1B illustrates a cross-sectional view of a UV digestion apparatus, in accordance with some embodiments.

FIG. 2A illustrates a cross-sectional view of a UV digestion apparatus when a first liquid is stored in a chamber of a liquid holder of the UV digestion apparatus, in accordance with some embodiments.

FIG. 2B illustrates a cross-sectional view of a UV digestion apparatus comprising a light source emitting UV light to a first liquid, in accordance with some embodiments.

FIG. 2C illustrates a representation of a structure of a metal chelate in a first liquid, in accordance with some embodiments.

FIG. 2D illustrates a cross-sectional view of a UV digestion apparatus when a first liquid exits a chamber of a liquid holder of the UV digestion apparatus, in accordance with some embodiments.

FIG. 2E illustrates use of a testing apparatus to determine a metal concentration of a UV-treated liquid, in accordance with some embodiments.

FIG. 3A illustrates a production system, in accordance with some embodiments.

FIG. 3B illustrates a production system, in accordance with some embodiments.

FIG. 3C illustrates a production system, in accordance with some embodiments.

FIG. 4 illustrates a semiconductor processing system, in accordance with some embodiments.

FIG. 5 is a flow diagram illustrating a method of measuring a metal concentration of a liquid, in accordance with some embodiments.

FIG. 6 illustrates an example computer-readable medium wherein processor-executable instructions configured to embody one or more of the provisions set forth herein may be comprised, according to some embodiments.

### DETAILED DESCRIPTION

The following disclosure provides several different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals or letters in the various examples. This repetition is for the purpose of simplicity and clarity and does not in itself dictate a relationship between the various embodiments or configurations discussed.

Further, spatially relative terms, such as “beneath,” “below,” “lower,” “above,” “upper” and the like, may be used herein for ease of description to describe one element or feature's relationship to other element(s) or feature(s) as illustrated in the figures. The spatially relative terms are intended to encompass different orientations of the device in use or operation in addition to the orientation illustrated in the figures. The apparatus may be otherwise oriented (rotated 90 degrees or at other orientations) and the spatially relative descriptors used herein may likewise be interpreted accordingly.

According to some embodiments, a system for determining a metal concentration of a liquid is provided. The system includes an ultraviolet (UV) digestion apparatus configured to treat the liquid with UV light to produce UV-treated liquid. In some embodiments, the UV digestion apparatus has a liquid holder defining a chamber in which the liquid is stored, and a light source configured to emit the UV light to the liquid. In some embodiments, the liquid comprises metal chelates, and the UV light decomposes the metal chelates into metal ions. The system includes a colorimetric testing apparatus to perform a colorimetric test on the UV-treated liquid to determine the metal concentration, such as a concentration of metal ions in the UV-treated liquid. In some embodiments, the metal concentration corresponds to a concentration of cobalt ions in the UV-treated liquid. Compared with some systems that attempt to perform a colorimetric test directly on the liquid without treating the liquid with UV light, the metal concentration is determined more accurately by performing the colorimetric test on the UV-treated liquid, such as due, at least in part, to the colorimetric test being more effective at measuring pure metals ions than measuring metals in chelated form.

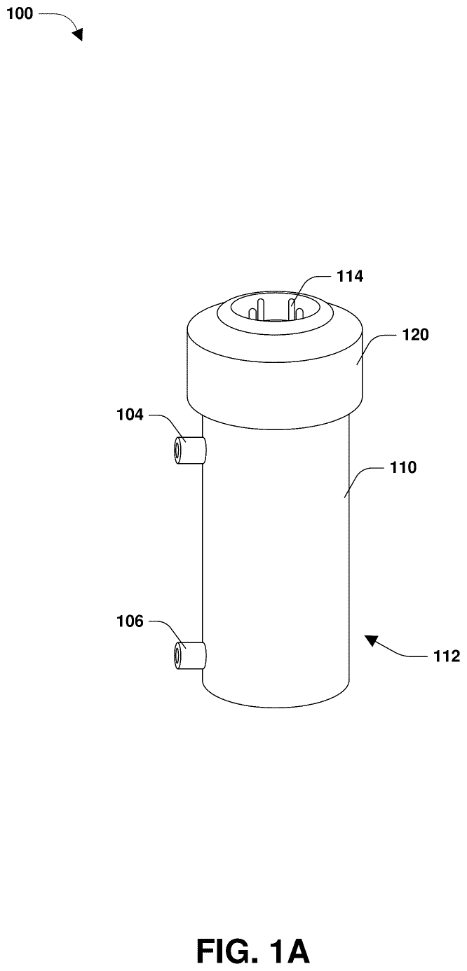

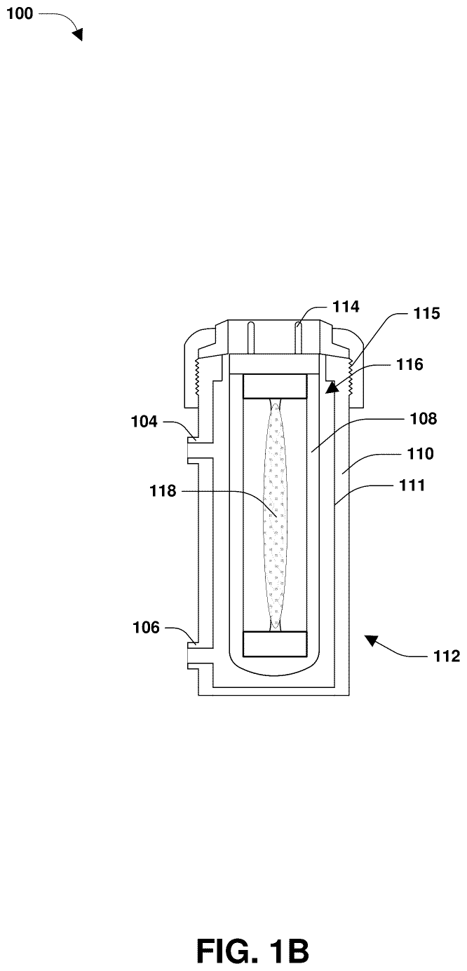

FIGS. 1A-1B illustrate an ultraviolet (UV) digestion apparatus 100 in accordance with some embodiments. FIG. 1A illustrates a perspective view of the UV digestion apparatus 100 in accordance with some embodiments. FIG. 1B illustrates a cross-sectional view of the UV digestion apparatus 100 in accordance with some embodiments. In some embodiments, the UV digestion apparatus 100 comprises a liquid holder 112 (shown in FIGS. 1A-1B) and a light source 118 (shown in FIG. 1B).

In some embodiments, the liquid holder 112 defines a chamber 116 in which a liquid is stored. In some embodiments, the liquid holder 112 comprises an outer wall 110 (shown in FIGS. 1A-1B) and an inner wall 108 (shown in FIG. 1B). In some embodiments, the outer wall 110 surrounds the inner wall 108. In some embodiments, the outer wall 110 is continuous so as to surround, encircle, etc. all of the inner wall 108. In some embodiments, the outer wall 110 is discontinuous or has a break so as to surround, encircle, etc. some but not all of the inner wall 108. In some embodiments, the chamber 116 is defined between the inner wall 108 and the outer wall 110. In some embodiments, the inner wall 108 surrounds the light source 118. In some embodiments, the inner wall 108 is continuous so as to surround, encircle, etc. all of the light source 118. In some embodiments, the inner wall 108 is discontinuous or has a break so as to surround, encircle, etc. some but not all of the light source 118. In some embodiments, the liquid holder 112 comprises an inlet 106 through which the liquid enters the chamber 116 of the liquid holder 112 and an outlet 104 through which the liquid exits the chamber 116 of the liquid holder 112.

In some embodiments, the UV digestion apparatus 100 comprises at least one of an apparatus head 120 (shown in FIGS. 1A-1B) or a connector 114 (shown in FIGS. 1A-1B). In some embodiments, the apparatus head 120 is in contact with the outer wall 110 of the liquid holder 112. In some embodiments, the apparatus head 120 defines an opening 122 in which the connector 114 is disposed. In some embodiments, the connector 114 is coupled to a power source (not shown). In some embodiments, the power source provides power to the light source 118 (e.g., electrical power to illuminate the light source 118) via the connector 114. In some embodiments, the apparatus head 120 is coupled to the liquid holder 112 using at least one of grooves, ridges, adhesive, etc. at an interface 115 (shown in FIG. 1B) between the apparatus head 120 and the liquid holder 112. In some embodiments, when the apparatus head 120 is coupled to the liquid holder 112, the apparatus head 120 supports and/or maintains a position of at least one of the light source 118 or the connector 114 relative to the liquid holder 112.

In some embodiments, the inner wall 108 of the liquid holder 112 comprises at least one of glass, one or more polymers, or other suitable material. In some embodiments, the inner wall 108 comprises a transparent material to provide for passage of light emitted by the light source 118 through the inner wall 108 to the liquid in the chamber 116. In some embodiments, the outer wall 110 comprises a reflective material to reflect light, such as light emitted by the light source 118, that impinges upon the outer wall 110. In some embodiments, an inner surface 111 (shown in FIG. 1B) of the outer wall 110 is coated with the reflective material. In some embodiments, the reflective material comprises at least one of steel, stainless steel, steel use stainless (SUS), or other suitable material. In some embodiments, the inner surface 111 of the outer wall 110 is polished, such as via electro polishing (EP) or other suitable techniques.

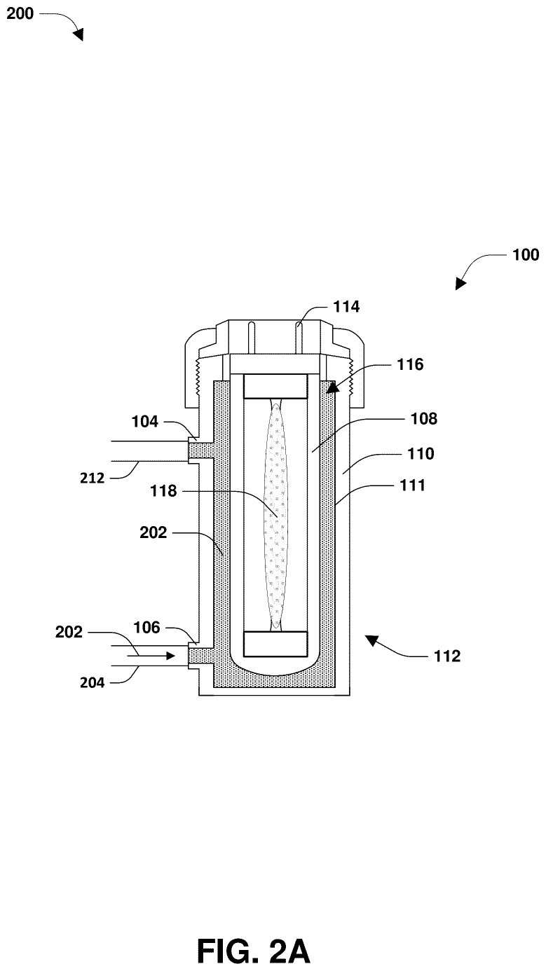

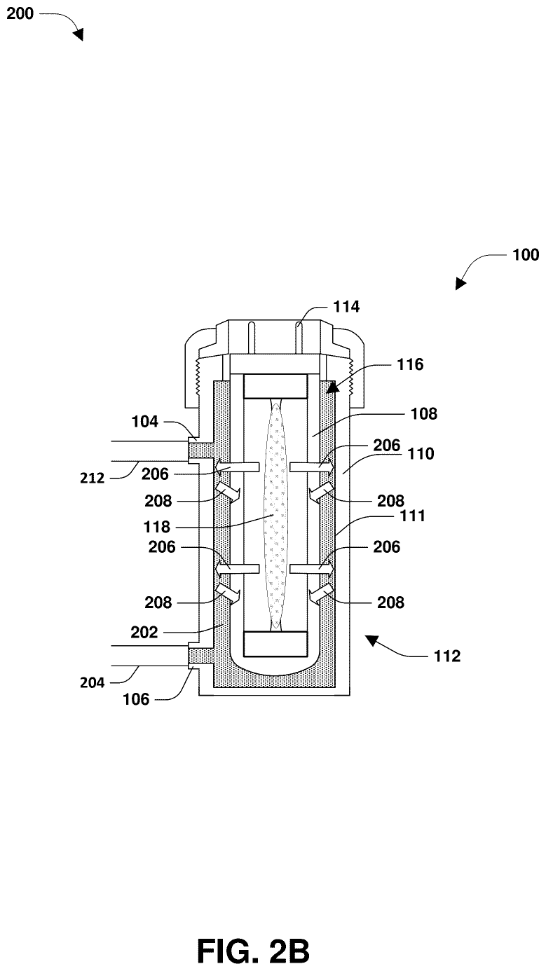

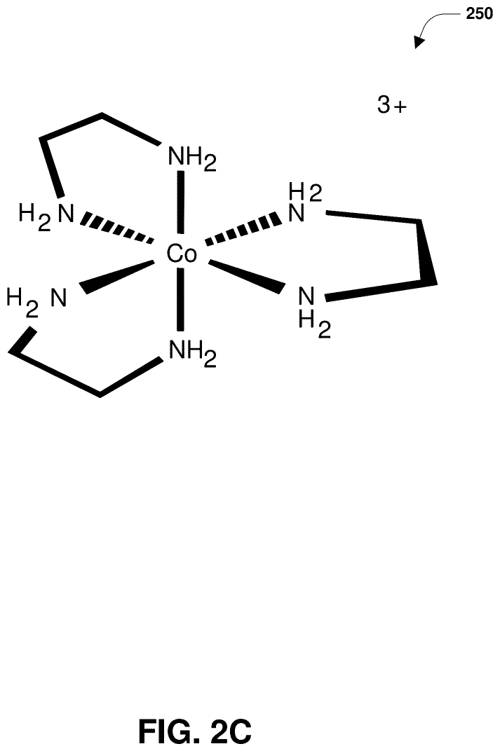

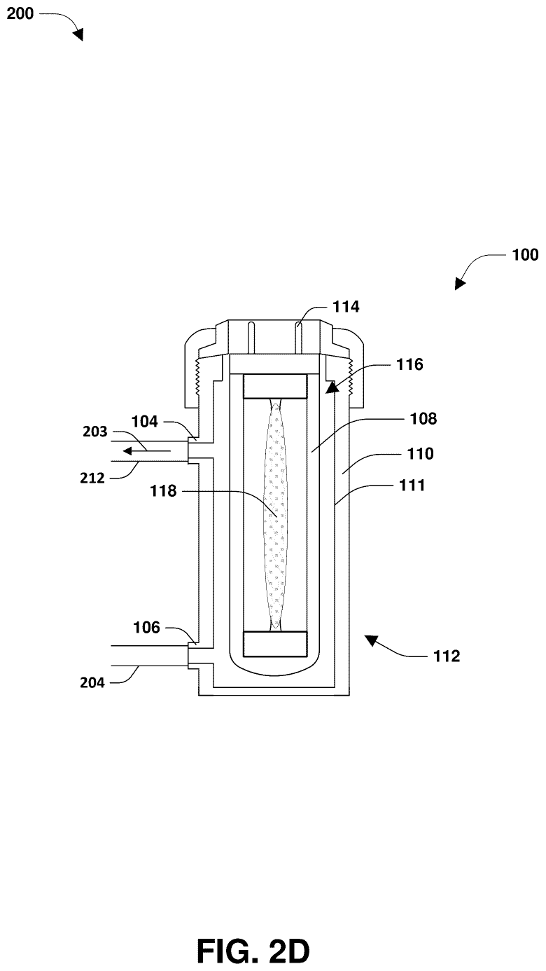

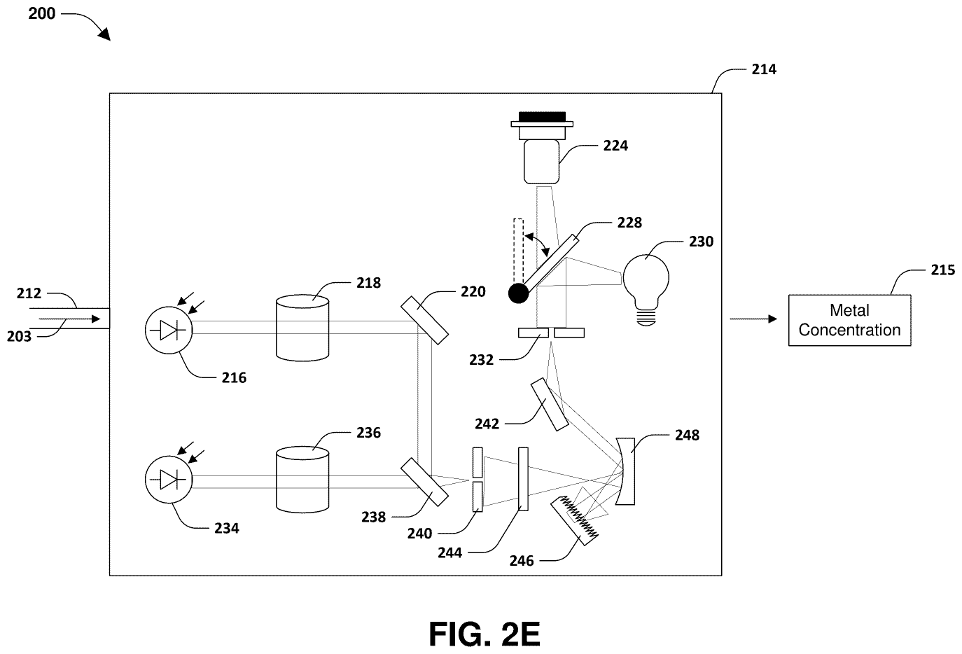

FIGS. 2A-2E illustrate a scenario 200 in which the UV digestion apparatus 100 is used for measuring a metal concentration of a liquid, in accordance with some embodiments. FIG. 2A illustrates a first liquid 202 stored in the chamber 116 of the liquid holder 112, in accordance with some embodiments. In some embodiments, the first liquid 202 is conducted through the inlet 106 into the chamber 116 using a conduit 204 (e.g., at least one of a pipe, a tube, a channel, etc.) coupled to the inlet 106. In some embodiments, the chamber 116 is at least partially filled by the first liquid 202. In some embodiments, the first liquid 202 is conducted into the chamber 116 using a pump (not shown). In some embodiments, the first liquid 202 comprises waste water. In some embodiments, the first liquid 202 comprises metal chelates.

FIG. 2B illustrates the light source 118 emitting UV light 206 to the first liquid 202, in accordance with some embodiments. In some embodiments, the light source 118 is activated to emit the UV light 206 in response to the chamber 116 of the liquid holder 112 being at least partially filled by the first liquid 202. In some embodiments, the UV light 206 comprises short-wave UV light. A wavelength of the UV light 206 is between about 100 nanometers to about 280 nanometers. Other values of the wavelength of the UV light 206 are within the scope of the present disclosure.

In some embodiments, the UV light 206 emitted from the light source 118 passes through the inner wall 108 and the first liquid 202 towards the outer wall 110. In some embodiments, the UV light 206 passes through the inner wall 108 due to the inner wall 108 comprising the transparent material. In some embodiments, upon impinging upon the outer wall 110, the UV light 206 is reflected back to the first liquid 202. In some embodiments, the UV light 206 is reflected back to the first liquid 202 due to the outer wall 110 comprising the reflective material. In some embodiments, the UV light 206 is reflected back to the first liquid 202 by the inner surface 111 of the outer wall 110. FIG. 2B illustrates reflections 208 of the UV light 206 as a result of the UV light 206 impinging upon the outer wall 110 comprising the reflective material. In some embodiments, the outer wall 110 comprising the reflective material and/or being polished provides for at least one of (i) increased amount of UV reflection paths of the UV light 206, (ii) increased uniformity of the UV reflection paths across the chamber 116 such that the UV light 206 treats a greater proportion of the first liquid 202 and/or decomposes a greater amount of metal chelates and/or other metal compounds in the first liquid 202, (iii) increased uniformity of the UV light 206 across the chamber 116 such that the first liquid 202 is treated with increased uniformity, (iv) enhanced energy superposition effect and/or dynamic superposition, or (v) enhanced bond-breaking of metal chelates and/or other metal compounds in the first liquid 202. In some embodiments, the outer wall 110 is not transparent to the UV light 206, thereby providing for a reduced amount of UV light that escapes the UV digestion apparatus 100 which provides for safer conditions since escaped UV light can have harmful health impacts on a person exposed to the escaped UV light.

In some embodiments, the UV light 206 decomposes metal chelates in the first liquid 202 into metal ions. In some embodiments, the metal chelates are decomposed into metal ions due, at least in part, to an energy level of the UV light 206 being greater than a bond disassociation energy of a chemical bond of a metal chelate such that the UV light 206 breaks the chemical bond. In some embodiments, the UV light 206 breaks chemical bonds of a compound to cause a metal ion of the compound to leave a chelated state. In some embodiments, the UV light 206 decomposes a compound (e.g., a chelated compound, a compressed compound, a surfactant, etc.) comprising a metal ion to at least one of (i) break chemical bonds of the compound, or (ii) separate the metal ion from other atoms and/or molecules of the compound. In some embodiments, the energy level of the UV light 206 is dependent upon the wavelength of the UV light 206. In some embodiments, the wavelength of the UV light 206 is about 185 nanometers and the energy level of the UV light 206 is about 647 kilojoules per mole such that the UV light 206 breaks chemical bonds with bond disassociation energies less than about 647 kilojoules per mole. In some embodiments, the wavelength of the UV light 206 is about 254 nanometers and the energy level of the UV light 206 is about 471 kilojoules per mole such that the UV light 206 breaks chemical bonds with bond disassociation energies less than about 471 kilojoules per mole.

FIG. 2C illustrates a representation 250 of a structure of a metal chelate in the first liquid 202, in accordance with some embodiments. The metal chelate comprises tris(ethylenediamine) cobalt (III) chloride comprising a cobalt ion. In some embodiments, the UV light 206 decomposes the metal chelate and/or separates the cobalt ion from other atoms and/or molecules of the metal chelate. Other types of metal chelates in the first liquid 202 are within the scope of the present disclosure.

In some embodiments, emitting the UV light 206 to the first liquid 202 produces UV-treated liquid 203 (shown in FIGS. 2D-2E). Compared with the first liquid 202, the UV-treated liquid 203 has a reduced amount of metal compounds (e.g., a reduced amount of chelated compounds, compressed compounds, surfactants, etc.), such as due, at least in part, to the UV light 206 decomposing compounds (e.g., chelated compounds, compressed compounds, surfactants, etc.) in the first liquid 202. Compared with the first liquid 202, the UV-treated liquid 203 has an increased amount of metal ions that are in a non-chelated state, such as due, at least in part, to the UV light 206 decomposing metal chelates in the first liquid 202.

In some embodiments, the light source 118 emits the UV light 206 to the first liquid 202 stored in the chamber 116 of the liquid holder 112 for a predefined duration of time to produce the UV-treated liquid 203. The predefined duration of time is between about five minutes to about 120 minutes. Other values of the predefined duration of time are within the scope of the present disclosure. In some embodiments, the predefined duration of time is configured such that at least a threshold proportion of metal chelates (and/or other types of metal compounds) in the first liquid 202 are decomposed into metal ions by the UV light 206.

FIG. 2D illustrates the chamber 116 of the liquid holder 112 emptied of the UV-treated liquid 203, in accordance with some embodiments. In some embodiments, the UV-treated liquid 203 exits the chamber 116 of the liquid holder 112 through the outlet 104 into a conduit 212 coupled to the outlet 104. In some embodiments, the conduit 212 conducts the UV-treated liquid 203 from the chamber 116 to a testing apparatus 214 (shown in FIG. 2E). In some embodiments, the UV-treated liquid 203 is conducted from the chamber 116 of the liquid holder 112 to the testing apparatus 214 in response to the light source 118 having emitted the UV light 206 to the first liquid 202 for the predefined duration of time to produce the UV-treated liquid 203.

FIG. 2E illustrates use of the testing apparatus 214 to determine a metal concentration 215 of the UV-treated liquid 203, in accordance with some embodiments. In some embodiments, the testing apparatus 214 comprises a colorimetric testing apparatus configured to perform a colorimetric test on the UV-treated liquid 203 to determine the metal concentration 215. In some embodiments, the colorimetric test uses a color reagent to determine the metal concentration 215. In some embodiments, the testing apparatus 214 comprises one or more components comprising at least one of (i) a first detector 216, (ii) a second detector 234, (iii) a reference cuvette 218, (iv) a sample cuvette 236, (v) a reflector 220, (vi) a semi-reflector 238, (vii) a light-in slit component 232, (viii) a light-out slit component 240, (ix) a filter 244, (x) a grating 246, (xi) a collimating mirror 248, (xii) a reflector 242, (xiii) a tungsten lamp 230, (xiv) a light switch 228, (xv) a deuterium lamp 224, or (xvi) one or more other components. In some embodiments, the testing apparatus 214 uses the one or more components to measure the metal concentration 215 of the UV-treated liquid 203.

In some embodiments, the testing apparatus 214 comprises a calibration module for calibrating the testing apparatus 214. In some embodiments, the calibration module comprises a calibration data structure indicative of measurement calibration curves associated with one or more operating parameters associated with the testing apparatus 214. In some embodiments, the measurement calibration curves comprise multi-parameter measurement calibration curves based upon temperature and humidity of an operating environment of the testing apparatus 214. In some embodiments, the measurement calibration curves comprise at least one of a first movement calibration curve for a first temperature and a first humidity of the operating environment, a second movement calibration curve for a second temperature and a second humidity of the operating environment, etc. In some embodiments, the calibration module at least one of (i) uses the calibration data structure to determine a measurement calibration curve for the colorimetric test based upon a current temperature and a current humidity of the operating environment of the testing apparatus 214, or (ii) performs calibration according to the measurement calibration curve before measuring the metal concentration 215. In some embodiments, the testing apparatus 214 comprising the calibration module enables the testing apparatus 214 to at least one of (i) self-calibrate (e.g., quickly self-calibrate), (ii) avoid measurement errors, or (iii) provide reference measurement results (e.g., quickly provide reference measurement results).

In some embodiments, the metal concentration 215 corresponds to a concentration of metal particles (e.g., metal ions) in the UV-treated liquid 203 (e.g., an amount of metal ions per unit of volume). In some embodiments, the metal concentration 215 corresponds to a cobalt concentration of the UV-treated liquid 203, such as a concentration of cobalt ions in the UV-treated liquid 203 (e.g., the first liquid 202 comprises cobalt compounds, such as cobalt chelates, which are decomposed into cobalt ions by the UV light 206 to produce the UV-treated liquid 203 comprising the cobalt ions, wherein the testing apparatus 214 analyzes the UV-treated liquid 203 to determine the concentration of cobalt ions in the UV-treated liquid 203).

In some embodiments, the metal concentration 215 corresponds to an aluminum concentration of the UV-treated liquid 203, such as a concentration of aluminum ions in the UV-treated liquid 203 (e.g., the first liquid 202 comprises aluminum compounds, such as aluminum chelates, which are decomposed into aluminum ions by the UV light 206 to produce the UV-treated liquid 203 comprising the aluminum ions, wherein the testing apparatus 214 analyzes the UV-treated liquid 203 to determine the concentration of aluminum ions in the UV-treated liquid 203). In some embodiments, the metal concentration 215 corresponds to an arsenic concentration of the UV-treated liquid 203, such as a concentration of arsenic ions in the UV-treated liquid 203 (e.g., the first liquid 202 comprises arsenic compounds, such as arsenic chelates, which are decomposed into arsenic ions by the UV light 206 to produce the UV-treated liquid 203 comprising the arsenic ions, wherein the testing apparatus 214 analyzes the UV-treated liquid 203 to determine the concentration of arsenic ions in the UV-treated liquid 203). In some embodiments, the metal concentration 215 corresponds to a barium concentration of the UV-treated liquid 203, such as a concentration of barium ions in the UV-treated liquid 203 (e.g., the first liquid 202 comprises barium compounds, such as barium chelates, which are decomposed into barium ions by the UV light 206 to produce the UV-treated liquid 203 comprising the barium ions, wherein the testing apparatus 214 analyzes the UV-treated liquid 203 to determine the concentration of barium ions in the UV-treated liquid 203).

In some embodiments, the metal concentration 215 corresponds to a cadmium concentration of the UV-treated liquid 203, such as a concentration of cadmium ions in the UV-treated liquid 203 (e.g., the first liquid 202 comprises cadmium compounds, such as cadmium chelates, which are decomposed into cadmium ions by the UV light 206 to produce the UV-treated liquid 203 comprising the cadmium ions, wherein the testing apparatus 214 analyzes the UV-treated liquid 203 to determine the concentration of cadmium ions in the UV-treated liquid 203). In some embodiments, the metal concentration 215 corresponds to a chromium concentration of the UV-treated liquid 203, such as a concentration of chromium ions in the UV-treated liquid 203 (e.g., the first liquid 202 comprises chromium compounds, such as chromium chelates, which are decomposed into chromium ions by the UV light 206 to produce the UV-treated liquid 203 comprising the chromium ions, wherein the testing apparatus 214 analyzes the UV-treated liquid 203 to determine the concentration of chromium ions in the UV-treated liquid 203). In some embodiments, the metal concentration 215 corresponds to a copper concentration of the UV-treated liquid 203, such as a concentration of copper ions in the UV-treated liquid 203 (e.g., the first liquid 202 comprises copper compounds, such as copper chelates, which are decomposed into copper ions by the UV light 206 to produce the UV-treated liquid 203 comprising the copper ions, wherein the testing apparatus 214 analyzes the UV-treated liquid 203 to determine the concentration of copper ions in the UV-treated liquid 203).

In some embodiments, the metal concentration 215 corresponds to an iron concentration of the UV-treated liquid 203, such as a concentration of iron ions in the UV-treated liquid 203 (e.g., the first liquid 202 comprises iron compounds, such as iron chelates, which are decomposed into iron ions by the UV light 206 to produce the UV-treated liquid 203 comprising the iron ions, wherein the testing apparatus 214 analyzes the UV-treated liquid 203 to determine the concentration of iron ions in the UV-treated liquid 203). In some embodiments, the metal concentration 215 corresponds to a ferrous iron concentration of the UV-treated liquid 203, such as a concentration of ferrous iron ions in the UV-treated liquid 203 (e.g., the first liquid 202 comprises ferrous iron compounds, such as ferrous iron chelates, which are decomposed into ferrous iron ions by the UV light 206 to produce the UV-treated liquid 203 comprising the ferrous iron ions, wherein the testing apparatus 214 analyzes the UV-treated liquid 203 to determine the concentration of ferrous iron ions in the UV-treated liquid 203). In some embodiments, the metal concentration 215 corresponds to a lead concentration of the UV-treated liquid 203, such as a concentration of lead ions in the UV-treated liquid 203 (e.g., the first liquid 202 comprises lead compounds, such as lead chelates, which are decomposed into lead ions by the UV light 206 to produce the UV-treated liquid 203 comprising the lead ions, wherein the testing apparatus 214 analyzes the UV-treated liquid 203 to determine the concentration of lead ions in the UV-treated liquid 203).

In some embodiments, the metal concentration 215 corresponds to a manganese concentration of the UV-treated liquid 203, such as a concentration of manganese ions in the UV-treated liquid 203 (e.g., the first liquid 202 comprises manganese compounds, such as manganese chelates, which are decomposed into manganese ions by the UV light 206 to produce the UV-treated liquid 203 comprising the manganese ions, wherein the testing apparatus 214 analyzes the UV-treated liquid 203 to determine the concentration of manganese ions in the UV-treated liquid 203). In some embodiments, the metal concentration 215 corresponds to a mercury concentration of the UV-treated liquid 203, such as a concentration of mercury ions in the UV-treated liquid 203 (e.g., the first liquid 202 comprises mercury compounds, such as mercury chelates, which are decomposed into mercury ions by the UV light 206 to produce the UV-treated liquid 203 comprising the mercury ions, wherein the testing apparatus 214 analyzes the UV-treated liquid 203 to determine the concentration of mercury ions in the UV-treated liquid 203). In some embodiments, the metal concentration 215 corresponds to a molybdenum concentration of the UV-treated liquid 203, such as a concentration of molybdenum ions in the UV-treated liquid 203 (e.g., the first liquid 202 comprises molybdenum compounds, such as molybdenum chelates, which are decomposed into molybdenum ions by the UV light 206 to produce the UV-treated liquid 203 comprising the molybdenum ions, wherein the testing apparatus 214 analyzes the UV-treated liquid 203 to determine the concentration of molybdenum ions in the UV-treated liquid 203).

In some embodiments, the metal concentration 215 corresponds to a molybdate concentration of the UV-treated liquid 203, such as a concentration of molybdate ions in the UV-treated liquid 203 (e.g., the first liquid 202 comprises molybdate compounds, such as molybdate chelates, which are decomposed into molybdate ions by the UV light 206 to produce the UV-treated liquid 203 comprising the molybdate ions, wherein the testing apparatus 214 analyzes the UV-treated liquid 203 to determine the concentration of molybdate ions in the UV-treated liquid 203). In some embodiments, the metal concentration 215 corresponds to a nickel concentration of the UV-treated liquid 203, such as a concentration of nickel ions in the UV-treated liquid 203 (e.g., the first liquid 202 comprises nickel compounds, such as nickel chelates, which are decomposed into nickel ions by the UV light 206 to produce the UV-treated liquid 203 comprising the nickel ions, wherein the testing apparatus 214 analyzes the UV-treated liquid 203 to determine the concentration of nickel ions in the UV-treated liquid 203). In some embodiments, the metal concentration 215 corresponds to a potassium concentration of the UV-treated liquid 203, such as a concentration of potassium ions in the UV-treated liquid 203 (e.g., the first liquid 202 comprises potassium compounds, such as potassium chelates, which are decomposed into potassium ions by the UV light 206 to produce the UV-treated liquid 203 comprising the potassium ions, wherein the testing apparatus 214 analyzes the UV-treated liquid 203 to determine the concentration of potassium ions in the UV-treated liquid 203).

In some embodiments, the metal concentration 215 corresponds to a selenium concentration of the UV-treated liquid 203, such as a concentration of selenium ions in the UV-treated liquid 203 (e.g., the first liquid 202 comprises selenium compounds, such as selenium chelates, which are decomposed into selenium ions by the UV light 206 to produce the UV-treated liquid 203 comprising the selenium ions, wherein the testing apparatus 214 analyzes the UV-treated liquid 203 to determine the concentration of selenium ions in the UV-treated liquid 203). In some embodiments, the metal concentration 215 corresponds to a silver concentration of the UV-treated liquid 203, such as a concentration of silver ions in the UV-treated liquid 203 (e.g., the first liquid 202 comprises silver compounds, such as silver chelates, which are decomposed into silver ions by the UV light 206 to produce the UV-treated liquid 203 comprising the silver ions, wherein the testing apparatus 214 analyzes the UV-treated liquid 203 to determine the concentration of silver ions in the UV-treated liquid 203). In some embodiments, the metal concentration 215 corresponds to a zinc concentration of the UV-treated liquid 203, such as a concentration of zinc ions in the UV-treated liquid 203 (e.g., the first liquid 202 comprises zinc compounds, such as zinc chelates, which are decomposed into zinc ions by the UV light 206 to produce the UV-treated liquid 203 comprising the zinc ions, wherein the testing apparatus 214 analyzes the UV-treated liquid 203 to determine the concentration of zinc ions in the UV-treated liquid 203).

Embodiments are contemplated in which one or more of the techniques of the present disclosure are used for measuring concentrations of other types of particles other than those explicitly provided herein.

Using the testing apparatus 214 to perform the first colorimetric test on the UV-treated liquid 203 provides for improved recovery rate of the first colorimetric test and/or improved accuracy of the metal concentration 215 in comparison with some systems that attempt to determine the metal concentration 215 by performing a colorimetric test directly on the first liquid 202 (without treating the first liquid 202 with the UV light 206, for example). Performing the colorimetric test directly on the first liquid 202 may result in an inaccurate metal concentration measurement (e.g., an inaccurate cobalt concentration), such as due, at least in part, metal ions (e.g., cobalt ions) of the first liquid 202 being bonded to metal chelates (and/or other metal compounds) that obstruct the colorimetric test and cause the colorimetric test to be unable to detect and/or measure at least some of the metal ions. In some embodiments, using the testing apparatus 214 to perform the first colorimetric test on the UV-treated liquid 203 provides for a first recovery rate of between about 83.7% to about 108.4%, whereas a system that performs the colorimetric test directly on the first liquid 202 may provide a recovery rate of about 9%.

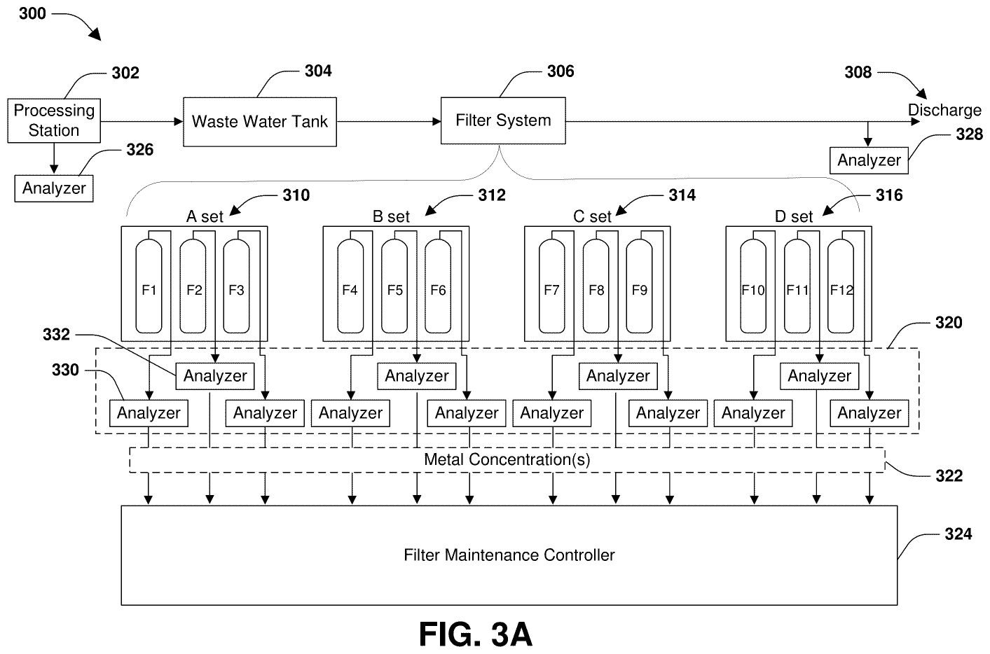

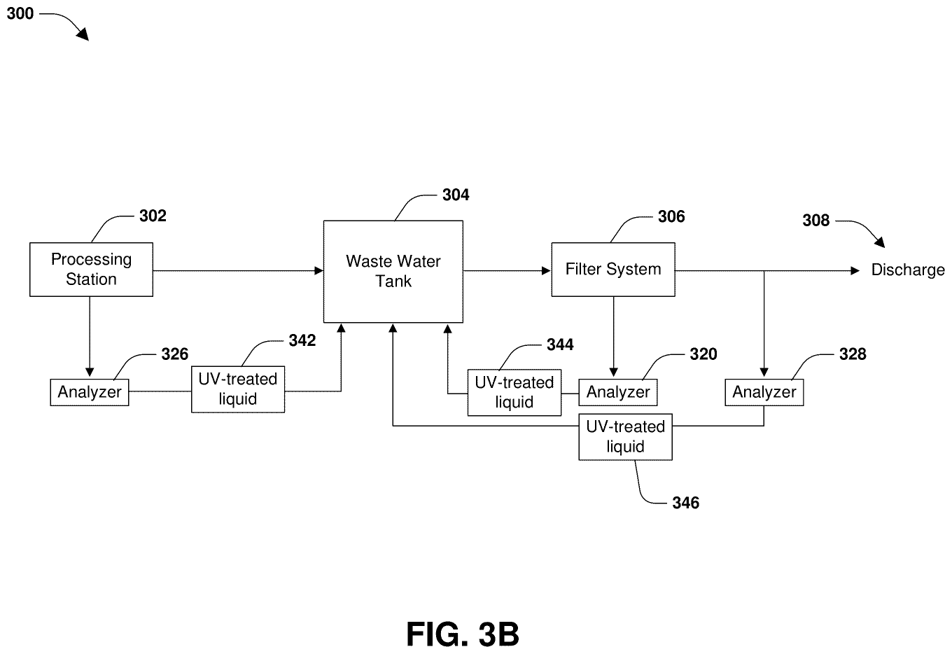

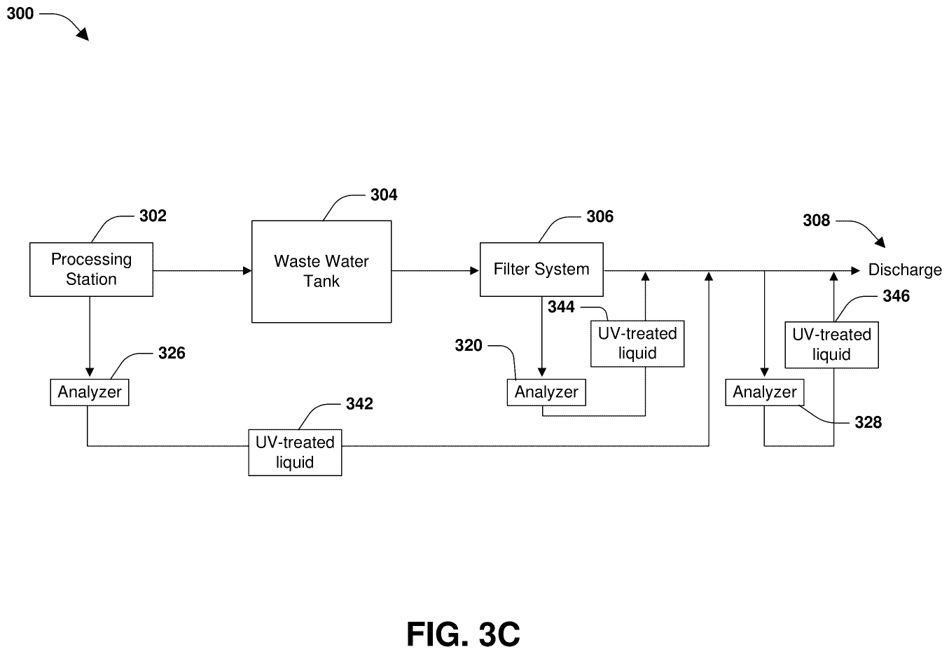

FIG. 3A illustrates a production system 300, in accordance with some embodiments. In some embodiments, the production system 300 comprises at least one of a set of analyzers, a processing station 302, a waste water collection tank 304, a filter system 306, or a filter maintenance controller 324. In some embodiments, the set of analyzers comprises at least one of a first analyzer 326, a second analyzer 328, or one or more analyzers 320. In some embodiments, each analyzer of one, some, or all of the set of analyzers comprises at least one of (i) a UV digestion apparatus (e.g., the UV digestion apparatus 100) for treating a liquid (e.g., the first liquid 202) with UV light to produce UV-treated liquid (e.g., the UV-treated liquid 203), or (ii) a testing apparatus (e.g., the testing apparatus 214) for measuring a metal concentration (e.g., the metal concentration 215) of the UV-treated liquid.

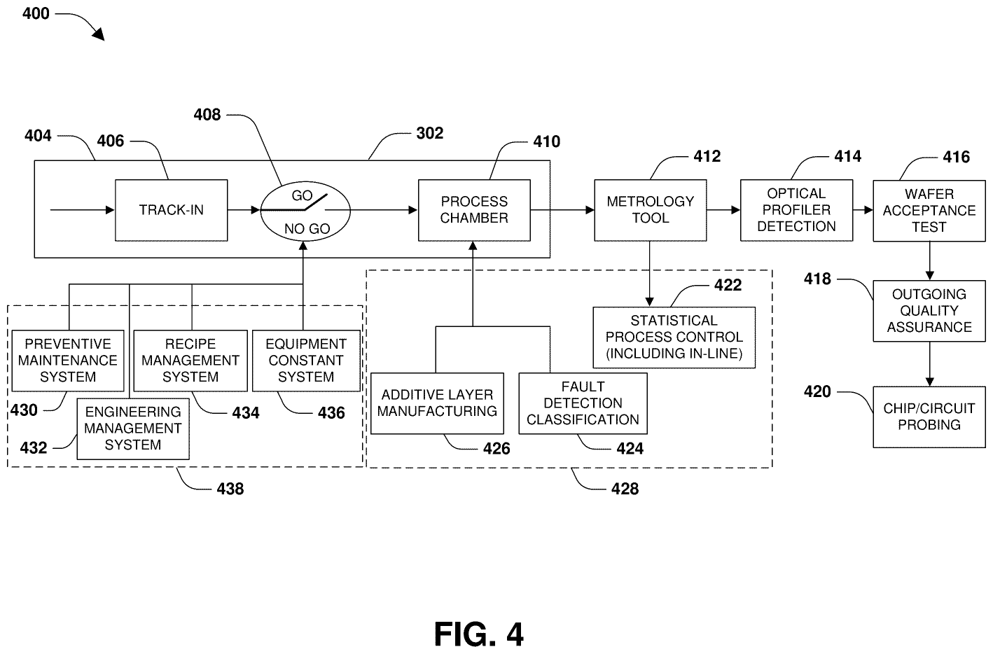

In some embodiments, the first analyzer 326 is configured to receive a second liquid (e.g., waste water) from the processing station 302. In some embodiments, the production system 300 comprises a conduit (not shown) configured to conduct the second liquid from the processing station 302 to the first analyzer 326. In some embodiments, the processing station 302 is configured to perform a first semiconductor fabrication process on a first semiconductor wafer to produce a processed semiconductor wafer. In some embodiments, the first semiconductor wafer comprises at least one of a substrate, a photomask, a semiconductor device, a die, etc. In some embodiments, the processing station 302 performs the first semiconductor fabrication process on the first semiconductor wafer while the first semiconductor wafer is in a processing chamber 410 (shown in FIG. 4) defined by one or more walls the processing station 302. In some embodiments, the processing station 302 comprises at least one of (i) ion implantation equipment, (ii) chemical vapor deposition (CVD) equipment, (iii) physical vapor deposition (PVD) equipment, (iv) etching equipment, such as at least one of plasma etching equipment, wet etching equipment, dry etching equipment, reactive-ion etching (RIE) equipment, atomic layer etching (ALE) equipment, buffered oxide etching equipment, or ion beam milling equipment, (v) lithography equipment, (vi) chemical mechanical planarization (CMP) equipment, (vii) plating equipment, (viii) cleaning equipment, (ix) a furnace, such as a semiconductor furnace tool, or (x) other equipment. In some embodiments, the first semiconductor fabrication process comprises at least one of an ion implantation process, a PVD process, a plating process, an etching process, a lithography process, a CMP process, a CVD process, a thermal process, a cleaning process, or other process.

In some embodiments, the second liquid comprises a processing liquid used by the processing station 302 to perform the first semiconductor fabrication process. In some embodiments, the second liquid comprises drainage from the processing station 302. In some embodiments, the second liquid is contaminated by one or more contaminants, such as metals (e.g., heavy metals), processing chemicals and/or materials used by the processing station 302 to perform the first semiconductor fabrication process. In some embodiments, the processing station 302 comprises electroless deposition (ELD) equipment and the first semiconductor fabrication process comprises an ELD process. In some embodiments, the second liquid comprises plating solution (e.g., electroless plating solution) used by the first semiconductor fabrication process to perform the ELD process. In some embodiments, the second liquid comprises plating bath liquid stored in a plating bath of the ELD equipment. In some embodiments, the second liquid comprises chelating agents. In some embodiments, the chelating agents are introduced to the second liquid to extend a service life of the second liquid (e.g., the electroless plating solution and/or the plating bath liquid), such as due, at least in part, to the chelating agents suppressing an increase of difficult-to-restore complexes associated with the second liquid. In some embodiments, the first semiconductor fabrication process is performed to form a metal structure on the first semiconductor wafer. In some embodiments, the metal structure comprises one or more metals that are deposited onto the first semiconductor wafer via the first semiconductor fabrication process. In some embodiments, the metal structure comprises at least one of a connection element, an interconnect structure, a contact, a via, a metal line, etc. In some embodiments, the metal structure establishes a connection between components (e.g., logic components, memory, transistors, electronic components, etc.) and/or layers (e.g., metal layers) of the first semiconductor wafer. In some embodiments, the chelating agents in the second liquid interact with the one or more metals used in the first semiconductor fabrication process to form chelated metals in the second liquid.

In some embodiments, the first analyzer 326 at least one of (i) uses a second UV digestion apparatus (e.g., the UV digestion apparatus 100) to treat the second liquid with second UV light to produce second UV-treated liquid, or (ii) uses a second testing apparatus (e.g., the testing apparatus 214) to determine a second metal concentration (e.g., the metal concentration 215) of the second UV-treated liquid. In some embodiments, the second metal concentration corresponds to a cobalt concentration of the second UV-treated liquid, such as a concentration of cobalt ions in the second UV-treated liquid. Other types of metal concentrations of the second metal concentration are within the scope of the present disclosure, such as at least one of aluminum concentration, arsenic concentration, etc. In some embodiments, the second liquid is treated using one or more of the techniques provided herein with respect to using the UV digestion apparatus 100 to treat the first liquid 202. In some embodiments, the second metal concentration is determined using one or more of the techniques provided herein with respect to using the testing apparatus 214 to determine the metal concentration 215.

In some embodiments, the first analyzer 326 provides the second metal concentration to a processing station controller (not shown). In some embodiments, the first analyzer 326 updates the second metal concentration in at least one of (i) a periodic manner, (ii) an aperiodic manner, or (iii) a continuous manner. In some embodiments, the first analyzer 326 updates the second metal concentration by (i) collecting a (new) sample of liquid from the processing station 302, (ii) using the second UV digestion apparatus to treat the sample of liquid with UV light to produce a sample of UV-treated liquid, or (iii) using the second testing apparatus to test the sample of UV-treated liquid to determine an updated value of the second metal concentration. In some embodiments, the first analyzer 326 provides the updated value of the second metal concentration to the processing station controller in response to determining the updated value. In some embodiments, the processing station controller uses the second metal concentration to at least one of control one or more parameters of the processing station 302 or schedule maintenance of the processing station 302. In some embodiments, the processing station controller determines a remaining service life of a processing liquid used by the processing station 302 based upon the second metal concentration, and schedules a maintenance event to replace the processing liquid based upon the remaining service life.

In some embodiments, the waste water collection tank 304 stores liquid (e.g., waste water) collected from one or more processing stations comprising at least one of the processing station 302, a second processing station (not shown), etc. In some embodiments, the liquid stored in the waste water collection tank 304 comprises at least one of drainage from a processing station, processing liquid used by a processing station, etc. In some embodiments, a conduit (not shown) is configured to conduct liquid from the processing station 302 to the waste water collection tank 304. In some embodiments, the production system 300 comprises a conduit (not shown) configured to conduct liquid from the waste water collection tank 304 to the filter system 306. In some embodiments, the filter system 306 comprises filters F1-F12. Although 12 filters are shown in FIG. 3A, any number of filters of the filter system 306 are within the scope of the present disclosure. In some embodiments, filters of the filter system 306 are arranged in groups, such as at least one of a first group of filters 310 (e.g., filters F1-F3), a second group of filters 312 (e.g., filters F4-F6), a third group of filters 314 (e.g., filters F7-F9), or a fourth group of filters 316 (e.g., filters F10-F12).

In some embodiments, each filter of one, some or all filters of the filter system 306 is configured to filter contaminants, such as metal particles, from liquid from the waste water collection tank 304 to produce filtered liquid. In some embodiments, for each filter of one, some or all filters of the filter system 306, the one or more analyzers 320 comprise an analyzer that at least one of (i) collects filtered liquid from the filter, (ii) uses a UV digestion apparatus (e.g., the UV digestion apparatus 100) to treat the filtered liquid with UV light to produce UV-treated liquid, (iii) uses a testing apparatus (e.g., the testing apparatus 214) to determine a metal concentration (e.g., the metal concentration 215) of the UV-treated liquid, or (iv) provides the metal concentration to the filter maintenance controller 324. In some embodiments, the one or more analyzers 320 provide one or more metal concentrations 322 to the filter maintenance controller 324.

In some embodiments, the one or more analyzers 320 comprise a third analyzer 330 configured to receive a third liquid (e.g., filtered waste water) from filter F1. In some embodiments, the production system 300 comprises a conduit (not shown) configured to conduct the third liquid from the filter F1 to the third analyzer 330. In some embodiments, the filter F1 performs a filtration process on a liquid (e.g., waste water) from the waste water collection tank 304 to produce the third liquid. In some embodiments, the filter F1 filters contaminants, such as metal particles, from the liquid to produce the third liquid. In some embodiments, the filter F1 comprises a resin filter comprising resin configured to adsorb the metal particles, such as via resin adsorption treatment. In some embodiments, when the liquid (e.g., waste water) from the waste water collection tank 304 flows through the filter F1, the resin in the filter F1 adsorbs metal particles (e.g., metal chelates, metal ions, etc.) in the liquid to separate the metal particles from the liquid to produce the third liquid without the metal particles. In some embodiments, the metal particles filtered by the filter F1 comprise at least one of cobalt particles, aluminum particles, arsenic particles, barium particles, cadmium particles, chromium particles, copper particles, iron particles, ferrous iron particles, lead particles, manganese particles, mercury particles, molybdenum particles, molybdate particles, nickel particles, potassium particles, selenium particles, silver particles, zinc particles, or other suitable metal particles.

In some embodiments, the third analyzer 330 at least one of (i) uses a third UV digestion apparatus (e.g., the UV digestion apparatus 100) to treat the third liquid with third UV light to produce third UV-treated liquid, or (ii) uses a third testing apparatus (e.g., the testing apparatus 214) to determine a third metal concentration (e.g., the metal concentration 215) of the third UV-treated liquid. In some embodiments, the third metal concentration corresponds to a cobalt concentration of the third UV-treated liquid, such as a concentration of cobalt ions in the third UV-treated liquid. Other types of metal concentrations of the third metal concentration are within the scope of the present disclosure, such as at least one of aluminum concentration, arsenic concentration, etc. In some embodiments, the third liquid is treated using one or more of the techniques provided herein with respect to using the UV digestion apparatus 100 to treat the first liquid 202. In some embodiments, the third metal concentration is determined using one or more of the techniques provided herein with respect to using the testing apparatus 214 to determine the metal concentration 215.

In some embodiments, the third analyzer 330 provides the third metal concentration to the filter maintenance controller 324. In some embodiments, the third analyzer 330 updates the third metal concentration in at least one of (i) a periodic manner, (ii) an aperiodic manner, or (iii) a continuous manner. In some embodiments, the third analyzer 330 updates the third metal concentration by (i) collecting a (new) sample of filtered liquid from the filter F1, (ii) using the third UV digestion apparatus to treat the sample of liquid with UV light to produce a sample of UV-treated liquid, or (iii) using the third testing apparatus to test the sample of UV-treated liquid to determine an updated value of the third metal concentration. In some embodiments, the third analyzer 330 provides the updated value of the third metal concentration to the filter maintenance controller 324 in response to determining the updated value.

In some embodiments, the filter maintenance controller 324 uses the third metal concentration to at least one of (i) determine a first filter status of the filter F1, or (ii) control maintenance of the filter F1. In some embodiments, the first filter status is indicative of at least one of (i) a saturation level of the filter F1, (ii) whether the filter F1 is saturated, or (iii) a remaining service life of the filter F1 (e.g., an amount of liquid the filter F1 can filter before becoming saturated). In some embodiments, the filter maintenance controller 324 performs one or more operations (e.g., mathematical operations) on the third metal concentration to determine the saturation level. In some embodiments, the saturation level is a function of the third metal concentration, where an increase of the third metal concentration corresponds to an increase of the saturation level. In some embodiments, the filter maintenance controller 324 compares the third metal concentration with a threshold metal concentration to determine whether the filter F1 is saturated. In some embodiments, the filter maintenance controller 324 determines that the filter F1 is saturated based upon a determination that the third metal concentration is greater than the threshold metal concentration. In some embodiments, the filter maintenance controller 324 determines that the filter F1 is saturated based upon a determination that the saturation level is greater than a threshold saturation level. In some embodiments, the filter maintenance controller 324 performs one or more operations (e.g., mathematical operations) on at least one of the third metal concentration or the saturation level to determine the remaining service life. In some embodiments, the remaining service life is a function of at least one of the third metal concentration or the saturation level, where an increase of at least one of the third metal concentration or the saturation level corresponds to a decrease of the remaining service life.

In some embodiments, the filter maintenance controller 324 schedules a maintenance operation for the filter F1 based upon the first filter status. In some embodiments, the filter maintenance controller 324 schedules the maintenance operation for a scheduled time in the future based upon a determination that the filter F1 is not saturated. In some embodiments, based upon a determination that the filter F1 is saturated, the filter maintenance controller 324 initiates the maintenance operation, such as by at least one of (i) outputting an indication that filter maintenance is needed for the filter F1, or (i) providing an instruction to a maintenance operator (e.g., a human, a robot, etc.) to perform the maintenance operation. In some embodiments, the maintenance operation comprises at least one of (i) replacing the filter F1 with a replacement filter, (ii) replacing used resin (e.g., saturated resin) of the filter F1 with replacement resin, (iii) flushing the filter F1 to reduce the saturation level of the filter F1, (iv) servicing the filter F1, or (v) one or more other suitable operations. In some embodiments, the filter maintenance controller 324 allocates one or more resources for the maintenance operation.

In some embodiments, the filter maintenance controller 324 updates the first filter status in at least one of (i) a periodic manner, (ii) an aperiodic manner, or (iii) a continuous manner. In some embodiments, the filter maintenance controller 324 updates the first filter status in response to receiving an updated value of the third metal concentration from the third analyzer 330. In some embodiments, the filter maintenance controller 324 monitors at least one of the first filter status or the third metal concentration (in real time, for example) to check whether the filter F1 is saturated, and at least one of (i) updates the scheduled time of the maintenance operation based upon changes to at least one of the first filter status or the third metal concentration, or (ii) initiates the maintenance operation in response to determining that the filter F1 is saturated.

In some embodiments, other analyzers of the one or more analyzers 320 are used to determine metal concentrations of filtered liquid from filters of the filter system 306 using one or more of the techniques provided herein with respect to using the third analyzer 330 to determine the third metal concentration associated with the filter F1. In some embodiments, the filter maintenance controller 324 schedules and/or controls maintenance of other filters (e.g., filters F2-F12) of the filter system 306 using one or more of the techniques provided herein with respect to scheduling and/or controlling maintenance of the filter F1.

In some embodiments, inflow distribution of filters of the filter system 306 is uneven such that the filter F1 filters a first amount of liquid per unit of time and filter F2 filters a second amount of liquid per unit of time. In some embodiments, the second amount of liquid per unit of time is greater than the first amount of liquid per unit of time such that the filter F2 such that an amount of time it takes for the filter F1 to become saturated is greater than an amount of time it takes for the filter F2 to become saturated. The filter maintenance controller 324 schedules a first maintenance operation on the filter F1 for a first scheduled time based upon at least one of the third metal concentration or the first filter status. The filter maintenance controller 324 schedules a second maintenance operation on the filter F2 for a second scheduled time based upon at least one of (i) a metal concentration, associated with the filter F2, determined using a fourth analyzer 332 using one or more of the techniques provided herein with respect to determining the third metal concentration using the third analyzer 330, or (ii) a second filter status, associated with the filter F2, determined using the filter maintenance controller 324 using one or more of the techniques provided herein with respect to determining the first filter status. In some embodiments, the second scheduled time is different than the first scheduled time, such as due, at least in part, to the filter F1 and the filter F2 taking different amounts of time to become saturated.

Some systems periodically replace all filters of the filter system 306 at regular intervals without determining filter statuses of the filters. In some embodiments, due to the inflow distribution of filters of the filter system 306 being uneven, replacing all of the filters of the filter system 306 at regular intervals results in (i) one or more first filters of the filter system 306 being replaced before the one or more first filters are saturated, thereby wasting remaining service life of the one or more first filters, or (ii) one or more second filters of the filter system 306 being replaced after the one or more second filters have been saturated for a period of time in which the one or more second filters ineffectively filter liquid from the waste water collection tank 304, thereby providing for discharge pollution. In some embodiments, compared with the one or more first filters, the one or more second filters are relatively overused, such as due, at least in part, to the inflow distribution of filters of the filter system 306 being uneven. Using one or more of the techniques of the present disclosure provides for improved filter management of the filter system 306 and/or more accurate maintenance of filters of the filter system 306, such as due, at least in part, to determining respective filter statuses of filters of the filter system 306 and using the filter statuses to accurately schedule maintenance operations of filters of the filter system 306, as opposed to periodically replacing filters of the filter system 306 at regular intervals without determining filter statuses of the filters. Thus, in accordance with some embodiments, the present disclosure provides for more efficient usage of filters of the filter system 306, such as due, at least in part, to the first maintenance operation being scheduled for a time when the saturation level is greater than the threshold saturation level, which may be reflective of a service life of the filter F1 nearing completion. In some embodiments, the present disclosure provides for reduced discharge pollution and improved environmental impact, such as due, at least in part, to the filter maintenance controller 324 initiating and/or scheduling the first maintenance operation for a time prior to completion of the service life of the filter F1.

In some embodiments, filtered liquid output by filters of the filter system 306 flows to a discharge path 308 that discharges effluent comprising the filtered liquid to an environment such as at least one of a surface water, a lake, a river, or other suitable environment. In some embodiments, the second analyzer 328 is configured to receive a fourth liquid comprising a sample of the effluent. In some embodiments, the second analyzer 328 at least one of (i) uses a fourth UV digestion apparatus (e.g., the UV digestion apparatus 100) to treat the fourth liquid with fourth UV light to produce fourth UV-treated liquid, or (ii) uses a fourth testing apparatus (e.g., the testing apparatus 214) to determine a fourth metal concentration (e.g., the metal concentration 215) of the fourth UV-treated liquid. In some embodiments, the fourth metal concentration corresponds to a cobalt concentration of the fourth UV-treated liquid, such as a concentration of cobalt ions in the fourth UV-treated liquid. Other types of metal concentrations of the fourth metal concentration are within the scope of the present disclosure, such as at least one of aluminum concentration, arsenic concentration, etc. In some embodiments, the fourth liquid is treated using one or more of the techniques provided herein with respect to using the UV digestion apparatus 100 to treat the first liquid 202. In some embodiments, the fourth metal concentration is determined using one or more of the techniques provided herein with respect to using the testing apparatus 214 to determine the metal concentration 215.

In some embodiments, the second analyzer 328 provides the fourth metal concentration to the filter maintenance controller 324. In some embodiments, the second analyzer 328 updates the fourth metal concentration in at least one of (i) a periodic manner, (ii) an aperiodic manner, or (iii) a continuous manner. In some embodiments, the second analyzer 328 updates the fourth metal concentration by (i) collecting a (new) sample of effluent, (ii) using the fourth UV digestion apparatus to treat the sample of liquid with UV light to produce a sample of UV-treated liquid, or (iii) using the fourth testing apparatus to test the sample of UV-treated liquid to determine an updated value of the fourth metal concentration.

In some embodiments, the production system 300 comprises a data structure module configured to automatically collect data from one, some, or all analyzers of the set of analyzers and use the data to generate a data structure (e.g., a table, a chart, etc.) indicating at least one of (i) one or more metal concentrations measured using one or more analyzers of the set of analyzers, or (ii) one or more filter statuses of one or more filters of the filter system 306. In some embodiments, the data structure module updates the data structure to provide a real time representation of metal concentrations and/or filter statuses. In some embodiments, the data structure module displays the data structure via a display screen. In some embodiments, each of one, some, or all analyzers of the set of analyzers comprises a communication device, such as a wireless or wired communication device, used to transmit data to at least one of the data structure module, the filter maintenance controller 324, or other component, thereby enabling real-time monitoring of metal concentrations and/or filter statuses.

In some embodiments, UV-treated liquid produced by an analyzer of the set of analyzers is conducted to the waste water collection tank 304. FIG. 3B illustrates the production system 300, in accordance with some embodiments in which UV-treated liquid is conducted to the waste water collection tank 304 from one, some, or all of the set of analyzers. In some embodiments, UV-treated liquid 342 is conducted from the first analyzer 326 to the waste water collection tank 304 using a conduit (not shown). In some embodiments, the UV-treated liquid 342 comprises the second UV-treated liquid measured by the second testing apparatus to determine the second metal concentration. In some embodiments, subsequent to conducting the UV-treated liquid 342 to the waste water collection tank 304, the UV-treated liquid 342 flows from the waste water collection tank 304 to the filter system 306 to be filtered by one or more filters (e.g., at least one of the filter F1, the filter F2, filter F3, etc.) of the filter system 306. In some embodiments, UV-treated liquid 344 is conducted from the one or more analyzers 320 to the waste water collection tank 304 using a conduit (not shown). In some embodiments, the UV-treated liquid 344 comprises the third UV-treated liquid measured by the third testing apparatus to determine the third metal concentration. In some embodiments, subsequent to conducting the UV-treated liquid 344 to the waste water collection tank 304, the UV-treated liquid 344 flows from the waste water collection tank 304 to the filter system 306 to be filtered by one or more filters (e.g., at least one of the filter F1, the filter F2, filter F3, etc.) of the filter system 306. In some embodiments, UV-treated liquid 346 is conducted from the second analyzer 328 to the waste water collection tank 304 using a conduit (not shown). In some embodiments, the UV-treated liquid 346 comprises the fourth UV-treated liquid measured by the fourth testing apparatus to determine the fourth metal concentration. In some embodiments, subsequent to conducting the UV-treated liquid 346 to the waste water collection tank 304, the UV-treated liquid 346 flows from the waste water collection tank 304 to the filter system 306 to be filtered by one or more filters (e.g., at least one of the filter F1, the filter F2, filter F3, etc.) of the filter system 306.

In some embodiments, UV-treated liquid produced by an analyzer of the set of analyzers is conducted to the discharge path 308 to be discharged to the environment. FIG. 3C illustrates the production system 300, in accordance with some embodiments in which UV-treated liquid is conducted to the discharge path 308 from one, some, or all of the set of analyzers. In some embodiments, the UV-treated liquid 342 is conducted from the first analyzer 326 to the discharge path 308 using a conduit (not shown). In some embodiments, the UV-treated liquid 344 is conducted from the one or more analyzers 320 to the discharge path 308 using a conduit (not shown). In some embodiments, the UV-treated liquid 346 is conducted from the second analyzer 328 to the discharge path 308 using a conduit (not shown).

FIG. 4 illustrates a semiconductor processing system 400 in accordance with some embodiments. In some embodiments, the semiconductor processing system 400 comprises the processing station 302. In some embodiments, the processing station 302 comprises at least one of a track-in component 406, a verification module 408 (e.g., go/no-go module), the processing chamber 410, or one or more other suitable components. In some embodiments, the track-in component 406 comprises one or more tracks of a transport system. In some embodiments, the one or more tracks comprise at least one of a rail, a race, a sidewall, etc. and are configured to accommodate a transport vehicle. In some embodiments, the transport vehicle travels along the one or more tracks of the track-in component 406 to transport a carrier carrying the first semiconductor wafer to the processing station 302 in a semiconductor manufacturing environment. In some embodiments, the transport vehicle comprises at least one of an overhead transport vehicle, a guided transport vehicle that travels on predetermined routes or tracks, a forklift, or other suitable vehicle. In some embodiments, the carrier comprises a wafer storage device. In some embodiments, the wafer storage device comprises at least one of a front opening unified pod (FOUP), a cassette pod, a reticle pod, or other type of wafer storage device. In some embodiments, the wafer storage device is used to store one or more semiconductor wafers comprising the first semiconductor wafer. In some embodiments, the one or more semiconductor wafers comprise a batch of wafers. In some embodiments, the verification module 408 performs a verification process to verify that one or more conditions associated with the first semiconductor wafer are met. In some embodiments, in response to determining that the one or more conditions are met, the verification module 408 allows the first semiconductor wafer to enter the processing chamber 410 of the processing station 302 to undergo the first semiconductor fabrication process. In some embodiments, in response to determining that the one or more conditions are not met, the verification module 408 does not allow the first semiconductor wafer to enter the processing chamber 410 of the processing station 302 and/or undergo the first semiconductor fabrication process. In some embodiments, the one or more conditions comprise at least one of (i) a condition that the first semiconductor wafer is in a suitable state, or (ii) a condition that the first semiconductor wafer does not have a defect.

In some embodiments, the semiconductor processing system 400 comprises at least one of one or more first components 438, one or more second components 428, a metrology tool 412, an optical profiler detection module 414, a wafer acceptance test module 416, an outgoing quality assurance module 418, a chip/circuit probing module 420, or one or more other suitable components. In some embodiments, the one or more first components 438 comprise at least one of a preventative maintenance system 430, a recipe management system 434, an engineering management system 432, an equipment constant system 436, or one or more other suitable components. In some embodiments, the one or more first components 438 are used to determine whether the one or more conditions associated with the first semiconductor wafer are met. In some embodiments, the one or more second components 428 comprise at least one of an additive layer manufacturing module 426, a fault detection classification module 424, a statistical process control module 422, or one or more other suitable components. In some embodiments, the one or more second components 428 are used to at least one of (i) control one or more parameters of the first semiconductor fabrication process, (ii) check whether the processed semiconductor wafer produced via the first semiconductor fabrication process is in a suitable state, or (iii) check whether the processed semiconductor wafer has a defect.

In some embodiments, the production system 300 comprises the semiconductor processing system 400.

In some embodiments, one, some, or all of the operations provided herein are performed automatically and/or without manual intervention to provide for (i) automatic determination and/or monitoring of a metal concentration of filtered liquid from a filter of the filter system 306, (ii) automatic determination and/or monitoring of a filter status of the filters, (iii) automatic scheduling and/or initiation of a maintenance operation for the filter based upon at least one of the metal concentration or the filter status.

Some systems attempt to use inductively coupled plasma mass spectrometer (ICP-MS) to measure the metal concentration 215. However, an ICP-MS tool is expensive and does not support on-site measurement. Thus, such systems require liquid samples to be shipped to remote facilities to be measured, thereby requiring a significant amount of time for a liquid to be measured. In some embodiments, using the UV digestion apparatus 100 and/or the testing apparatus 214 to determine the metal concentration 215 using one or more of the techniques provided herein provides for at least one of (i) significantly reduced cost in comparison with the ICP-MS tool, (ii) on-site measurement of metal concentrations in a production environment associated with the production system 300, or (iii) real-time measurement of metal concentrations without delays associated with manually gathering samples and shipping the samples to remote facilities.

In some embodiments, using the UV digestion apparatus 100 and/or the testing apparatus 214 to determine the metal concentration 215 using one or more of the techniques provided herein provides for at least one of automatic sampling and/or analysis and/or no need (and/or reduced need) to arrange specific personnel for sampling and analysis, whereas some measurement systems, such as ICP-MS systems, require specific personnel (e.g., trained laboratory experts).

Embodiments are contemplated in which the processing station 302 is used to perform a process other than a semiconductor fabrication process.

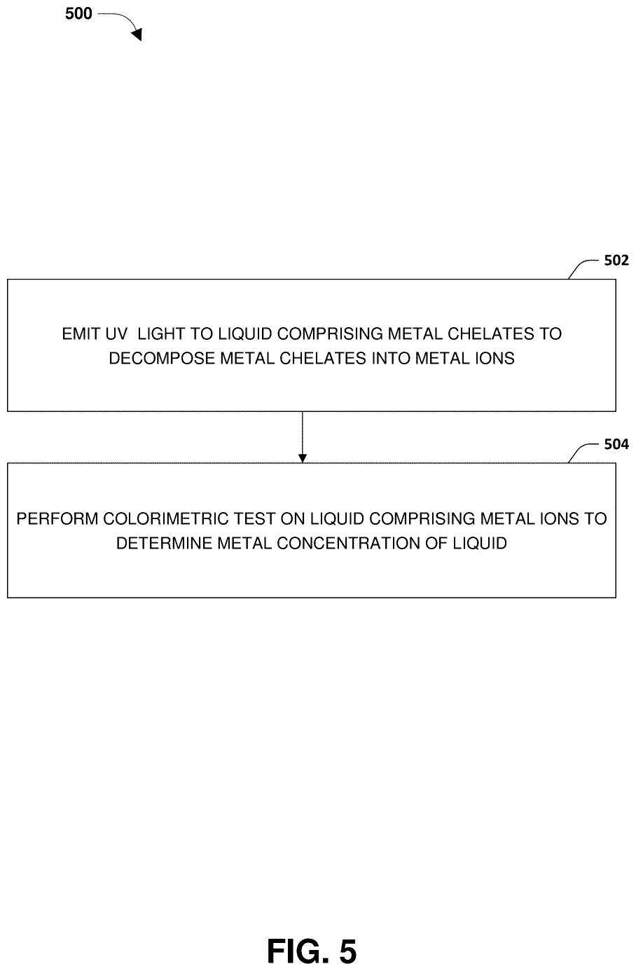

A method 500 of measuring a metal concentration of a liquid, is illustrated in FIG. 5 in accordance with some embodiments. At 502, a UV light is emitted to a liquid comprising metal chelates to decompose the metal chelates into metal ions. In some embodiments, at least one of (i) the UV light comprises the UV light 206 (shown in FIG. 2B), or (ii) the liquid comprises the first liquid 202 (shown in FIGS. 2A-2B). At 504, a colorimetric test is performed on the liquid comprising the metal ions to determine a metal concentration of the liquid. In some embodiments, at least one of (i) the colorimetric test is performed using the testing apparatus 214 (shown in FIG. 2E), (ii) the liquid (comprising the metal ions) on which the colorimetric test is performed comprises the UV-treated liquid 203 (shown in FIGS. 2D-2E), or (iii) the metal concentration comprises the metal concentration 215 (shown in FIG. 2E).

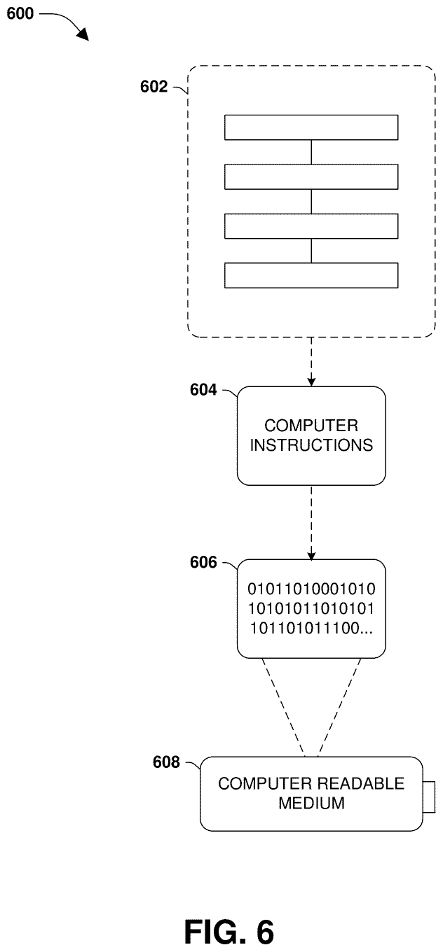

One or more embodiments involve a computer-readable medium comprising processor-executable instructions configured to implement one or more of the techniques presented herein. An exemplary computer-readable medium is illustrated in FIG. 6, wherein the embodiment 600 comprises a computer-readable medium 608 (e.g., a CD-R, DVD-R, flash drive, a platter of a hard disk drive, etc.), on which is encoded computer-readable data 606. This computer-readable data 606 in turn comprises a set of processor-executable computer instructions 604 configured to implement one or more of the principles set forth herein when executed by a processor. In some embodiments 600, the processor-executable computer instructions 604 are configured to implement a method 602, such as at least some of the aforementioned method(s) when executed by a processor. In some embodiments, the processor-executable computer instructions 604 are configured to implement a system, such as at least some of the one or more aforementioned system(s) when executed by a processor. Many such computer-readable media may be devised by those of ordinary skill in the art that are configured to operate in accordance with the techniques presented herein.

In some embodiments, a system is provided. The system includes a UV digestion apparatus and a colorimetric testing apparatus. The UV digestion apparatus includes a liquid holder defining a chamber and a light source configured to emit UV light to the chamber. The colorimetric testing apparatus is configured to perform a colorimetric test to determine a metal concentration.

In some embodiments, a method is provided. The method includes emitting UV light to a liquid including metal chelates to decompose the metal chelates into metal ions. The method includes performing a colorimetric test on the liquid including the metal ions to determine a metal concentration of the liquid.

In some embodiments, a UV digestion apparatus is provided. The UV digestion apparatus includes a light source and a liquid holder comprising an inner wall surrounding the light source and an outer wall surrounding the inner wall. A chamber is defined between the inner wall and the outer wall. A liquid including metal chelates is stored in the chamber. The light source is configured to emit UV light to the liquid to decompose the metal chelates into metal ions.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

Although the subject matter has been described in language specific to structural features or methodological acts, it is to be understood that the subject matter of the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

It will be appreciated that layers, features, elements, etc. depicted herein are illustrated with particular dimensions relative to one another, such as structural dimensions or orientations, for example, for purposes of simplicity and ease of understanding and that actual dimensions of the same differ substantially from that illustrated herein, in some embodiments. Additionally, a variety of techniques exist for forming layers, regions, features, elements, etc. mentioned herein, such as at least one of etching techniques, planarization techniques, implanting techniques, doping techniques, spin-on techniques, sputtering techniques, growth techniques, or deposition techniques such as chemical vapor deposition (CVD), for example.

Moreover, “exemplary” and/or the like is used herein to mean serving as an example, instance, illustration, etc., and not necessarily as advantageous. As used in this application, “or” is intended to mean an inclusive “or” rather than an exclusive “or”. In addition, “a” and “an” as used in this application and the appended claims are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used, such terms are intended to be inclusive in a manner similar to the term “comprising”. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others of ordinary skill in the art based upon a reading and understanding of this specification and the annexed drawings. The disclosure comprises all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A system, comprising:
an ultraviolet (UV) digestion apparatus comprising:
a liquid holder defining a chamber; and
a light source configured to emit UV light to the chamber; and
a colorimetric testing apparatus configured to perform a colorimetric test to determine a metal concentration.

2. The system of claim 1, wherein the liquid holder comprises:
an inner wall surrounding the light source; and
an outer wall surrounding the inner wall, wherein the chamber is defined between the inner wall and the outer wall.

3. The system of claim 2, wherein:
the UV light emitted from the light source passes through the inner wall and the chamber towards the outer wall;
the outer wall comprises a reflective material; and
the UV light is reflected upon impinging upon the outer wall.

4. The system of claim 2, wherein:
the inner wall comprises a transparent material to provide for passage of the UV light through the inner wall.

5. The system of claim 1, wherein:
a wavelength of the UV light is between about 100 nanometers to about 280 nanometers.

6. The system of claim 1, wherein:
a liquid comprising metal chelates is stored in the chamber of the liquid holder;
the UV light emitted by the light source decomposes the metal chelates into metal ions; and
the colorimetric testing apparatus is configured to perform the colorimetric test on the liquid comprising the metal chelates to determine the metal concentration of the liquid.

7. The system of claim 6, wherein:
the metal chelates comprise cobalt chelates; and
the metal ions comprise cobalt ions.

8. The system of claim 6, comprising:
a filter configured to filter metal particles from a second liquid to produce the liquid.

9. The system of claim 8, comprising:
a filter maintenance controller configured to schedule a maintenance operation for the filter based upon the metal concentration.

10. The system of claim 8, wherein:
the filter comprises a resin filter.

11. The system of claim 8, comprising:
a liquid collection tank configured to store liquid from one or more semiconductor processing stations; and
a conduit configured to conduct the second liquid from the liquid collection tank to the filter.

12. A method, comprising:
emitting ultraviolet (UV) light to a liquid comprising metal chelates to decompose the metal chelates into metal ions; and
performing a colorimetric test on the liquid comprising the metal ions to determine a metal concentration of the liquid.

13. The method of claim 12, comprising:
transferring a second liquid from a semiconductor processing station to a filter; and
filtering, by the filter, metal particles from the second liquid to produce the liquid.

14. The method of claim 13, comprising:
scheduling a maintenance operation for the filter based upon the metal concentration.

15. The method of claim 12, wherein:
emitting the UV light comprises emitting light having a wavelength between about 100 nanometers to about 280 nanometers.

16. The method of claim 12, comprising:
prior to performing the colorimetric test, transferring the liquid comprising the metal ions to a colorimetric testing apparatus, wherein performing the colorimetric test on the liquid comprises performing the colorimetric test using the colorimetric testing apparatus.

17. An ultraviolet (UV) digestion apparatus comprising:
a light source; and
a liquid holder comprising:
an inner wall surrounding the light source; and
an outer wall surrounding the inner wall,
wherein:
a chamber is defined between the inner wall and the outer wall;
a liquid comprising metal chelates is stored in the chamber; and
the light source is configured to emit UV light to the liquid to decompose the metal chelates into metal ions.

18. A system comprising:
the UV digestion apparatus of claim 17; and
a testing apparatus configured to perform a test on the liquid comprising the metal ions to determine a metal concentration of the liquid.

19. The UV digestion apparatus of claim 17, wherein:
the UV light emitted from the light source passes through the inner wall and the liquid towards the outer wall;
the outer wall comprises a reflective material; and
upon impinging upon the outer wall, the UV light is reflected back to the liquid in the chamber.

20. The UV digestion apparatus of claim 17, wherein:
the inner wall comprises a transparent material to provide for passage of the UV light through the inner wall to the liquid in the chamber.
